(19) United States
(12) Patent Application Publication
(10) Pub. No.: US 2007/0287477 A1
(43) Pub. Date: Dec. 13, 2007

(54) Mobile device with shakeable snow rendering

(75) Inventor: Bao Q. Tran, San Jose, CA (US)

Correspondence Address: TRAN & ASSOCIATES, 6768 MEADOW VISTA CT., SAN JOSE, CA, 95135, US

(73) Assignee: AVAILABLE FOR LICENSING

(21) Appl. No.: 11/451,173

(22) Filed: Jun. 12, 2006

(51) Int. Cl. H04Q 7/20

(52) U.S. Cl. 455/466

(57) ABSTRACT

Systems and methods render graphics on a mobile device by accepting a request for a first multimedia file (video or picture); rendering the first multimedia file; accepting a request for a second multimedia file; transitioning the first multimedia file into the second multimedia file; and rendering the second multimedia file. The transition may include snow-flake effects.

### BACKGROUND

During past years, several network operators around the world have introduced personalized RingBack Tone (RBT) services. Such a service enables a subscriber to choose a custom audio clip (e.g., a favorite song) to be played back to a caller phone during a ringing portion of a call, prior to the subscriber answering the call. Hence, instead of hearing a standard ring-back tone (at the caller phone) indicating that a target phone is being alerted of the incoming call connection request, the caller hears the custom audio clip selected by the subscriber. The subscriber of the custom ring-back tone service may specify one of several audio clips to be played by a respective phone switch network based on caller identification, time-of-day, or other factors.

As noted in Application Serial Nos. 20050117726 and 20060013377, the contents of which are incorporated by reference, a common architecture for providing custom ring-back tone includes a Mobile Switching Center (MSC), a Home Location Register (HLR), and a ring-back tone generator. In this architecture, software in a network operator's MSC, in conjunction with the Home Location Register (HLR), identifies which received calls have been placed to corresponding subscribers of the ring-back service. For such calls, the MSC sets up a voice path to the ring-back tone generator for conveying a ring-back tone to the caller phone while also placing an outbound call connection to alert the subscriber of the call placed by the caller phone. The ring-back tone generator then plays the selected audio clip back to the caller through the voice path while the subscriber phone is alerted of the incoming call connection request. When the MSC detects that the subscriber answers his alerting phone, or the target phone abandons the call, the MSC releases the voice path to the ring-back tone generator and continues on with normal call handling. For example, after detecting that the subscriber answers his phone, the MSC breaks a link to the ring-back tone generator and bridges the caller phone to the subscriber phone via a voice communication channel so that the subscriber and the caller can talk with each other without the custom ring-back tone being played.

On a parallel note, Short Message Service (SMS) is a mechanism of delivery of short messages over the mobile networks and provides the ability to send and receive text messages to and from mobile devices. A GSM network supporting messaging such as SMS provides a store and forward way of transmitting messages to and from mobiles. The message (text only) from the sending mobile is stored in a central short message center (SMSC) which then forwards it to the destination mobile. The SMSC stores/forwards messages to and from the mobile station. The SME (Short Message Entity), which is typically a mobile phone or a GSM modem, can be located in the fixed network or a mobile station, receives and sends short messages. The SMS GMSC (SMS gateway MSC) is a gateway MSC that can also receive short messages. The gateway MSC is a mobile network's point of contact with other networks. On receiving the short message from the short message center, GMSC uses the SS7 network to interrogate the current position of the mobile station form the HLR, the home location register. HLR is the main database in a mobile network. It holds information of the subscription profile of the mobile and also about the routing information for the subscriber, i.e. the area (covered by a MSC) where the mobile is currently situated. The GMSC is thus able to pass on the message to the correct MSC. The MSC (Mobile Switching Center) is the entity in a GSM network which does the job of switching connections between mobile stations or between mobile stations and the fixed network. A VLR (Visitor Location Register) corresponds to each MSC and contains temporary information about the mobile, information like mobile identification and the cell (or a group of cells) where the mobile is currently situated. Using information form the VLR the MSC is able to switch the information (short message) to the corresponding BSS (Base Station System, BSC+BTSs), which transmits the short message to the mobile. The BSS consists of transceivers, which send and receive information over the air interface, to and from the mobile station. This information is passed over the signaling channels so the mobile can receive messages even if a voice or data call is going on.

In addition to SMS, Smart Messaging (from Nokia), EMS (Enhanced Messaging System) and MMS (Multimedia Messaging Service) have emerged. MMS adds images, text, audio clips and ultimately, video clips to SMS (Short Message Service/text messaging). Nokia created a proprietary extension to SMS called ‘Smart Messaging’ that is available on more recent Nokia phones. Smart messaging is used for services like Over The Air (OTA) service configuration, phone updates, picture messaging, operator logos etc. Smart Messaging is rendered over conventional SMS and does not need the operator to upgrade their infrastructure. SMS eventually will evolve toward MMS, which is accepted as a standard by the 3GPP standard. MMS enables the sending of messages with rich media such as sounds, pictures and eventually, even video. MMS itself is emerging in two phases, depending on the underlying bearer technology—the first phase being based on GPRS (2.5G) as a bearer, rather than 3G. This means that initially MMS will be very similar to a short PowerPoint presentation on a mobile phone (i.e. a series of “slides” featuring color graphics and sound). Once 3G is deployed, sophisticated features like streaming video can be introduced. The road from SMS to MMS involves an optional evolutionary path called EMS (Enhanced Messaging System). EMS is also a standard accepted by the 3GPP.

### SUMMARY

In a first aspect, a method to render graphics on a mobile device includes requesting a first multimedia file; rendering the first multimedia file; requesting a second multimedia file; transitioning the first multimedia file into the second multimedia file; and rendering the second multimedia file.

Implementations of the above aspects can include one or more of the following. The system can receive an accelerometer sensor output to indicate a new file is to be played. The transitioning can include converting one or more frames of the first multimedia file into screen fragments and reassembling the screen fragments over one or more frames of the second multimedia file. The system can download one or more multimedia files from a server to the mobile device. The multimedia files can be micro-chunks. The system can capture a multimedia file using a camera on the mobile device and edit the multimedia file on the mobile device or on a personal computer. The multimedia file can be sound, images, or videos. One multimedia file can transition into another file with cut, fade, crossfade, wipes, digital effect, or morphing transitions, among others. The mobile device can be a plain old mobile device service (POTS) mobile device, a Voice Over Internet Protocol (VOIP) mobile device, a cellular mobile device, a WiFi mobile device, or a WiMAX mobile device, among others. Automated position determination can be done with triangulation based location determination, WiFi location determination, GPS, assisted GPS, GLONASS, assisted GLONASS, GALILEO, or assisted GALILEO, for example. The system can receive a search query and searching one or more taxonomic databases based on the search query and return a search result to the mobile device. The taxonomic databases can cover topics such as music, food, restaurant, movie, map, mobile device directory, news, blogs, weather, stocks, calendar, sports, horoscopes, lottery, messages, traffic, or direction. The multimedia files can be communicated using MMS.

In another aspect, a mobile device includes a gesture input device; a display; and a processor having code to receive a request for a first multimedia file; code to render the first multimedia file; code to receive a request for a second multimedia file; code to transition the first multimedia file into the second multimedia file; and code to render the second multimedia file.

In implementations of the mobile device, the gesture input device can be an accelerometer, a tilt sensor, a gyroscope, a skin resistance sensor, an electro-myogram (EMG) sensor, an Electro-encephalogram (EEG) sensor, and Electro-oculogram (EOG) sensor, or an electrocardiogram (EKG) sensor. The processor converts one or more frames of the first multimedia file into screen fragments and reassembling the screen fragments over one or more frames of the second multimedia file. A server can store files to download one or more multimedia files to the mobile device. The multimedia file can be a microchunk. A phone camera can capture a multimedia file which can be edited on the mobile device or on a desktop PC.

In another aspect, a method to operate a mobile device includes receiving a search query from the mobile device; transmitting the search query to a search engine; searching one or more taxonomic databases based on the search query; and returning a search result to display on the mobile device.

In yet another aspect, a system includes a mobile device coupled to a wide area network; and a server coupled to the mobile device over the wide area network, the server receiving a search query from the mobile device; the server searching one or more taxonomic databases based on the search query and returning a search result to the mobile device.

In yet another aspect, a system includes a handheld mobile device coupled to a plain old mobile device service (POTS) or a public switched mobile device network (PSTN), the handheld mobile device having a modem; a server coupled to the mobile device over the POTS or PSTN, the server receiving a search query from the mobile device; the server searching one or more databases based on the search query and returning a search result to display on the mobile device.

In a further aspect, a mobile device system for making free VOIP calls includes a handset with a display, a keypad, and a modem communicating with a remote server. The user make local and long distance calls for free and in addition may have access to value added services that include but not be limited to music, food, restaurant, movie, map, mobile device directory, news, blogs, weather, stocks, calendar, sports, horoscopes, lottery, messages, or traffic database. The display of the phone periodically shows information of interest to the user (such as ads), based on a profile that the user makes when registering with the system. The profile is updated to track services and products as the user actually uses.

Implementations of the above may include one or more of the following. The system can capture a verbal search request and transmitting the verbal search request to the search engine. The verbal search request comprises one of: phoneme, diphone, triphone, syllable, demisyllable, cepstral coefficient, cepstrum coefficient. The search user can designate an entity from one of the search results to call back the mobile device. One way to select is to click on a link and click on a subsequent button to confirm that the company associated with the link should call the user's mobile device and the system can transmit the mobile device's caller identification (Caller ID) number to the entity for calling back the mobile device. The entity pays a fee for each Caller ID for referral fee, advertising fee, membership fee, or any other suitable business model fees. The mobile device can be a Voice Over Internet Protocol (VOIP) mobile device, a cellular mobile device, a WiFi mobile device, a WiMAX mobile device. The phone can provide directions to one of: a store, a retailer, a company, a venue. The taxonomic databases can be music, food, restaurant, movie, map, mobile device directory, news, blogs, weather, stocks, calendar, sports, horoscopes, lottery, messages, or traffic database. The system can perform automated position determination with one of: triangulation based location determination, WiFi location determination, GPS, assisted GPS, GLONASS, assisted GLONASS, GALILEO, assisted GALILEO.

In yet another aspect, systems and methods are disclosed to operate a mobile device. The system includes a message center; an engine coupled to the message center; and a mobile device wirelessly coupled to the message center, wherein the engine specifies one or more meeting locations and wherein at least one meeting location comprises a location designated by an advertiser.

In another aspect, systems and methods are disclosed to operate a mobile device by capturing user speech; converting the user speech into one or more speech symbols; transmitting the speech symbols over a wireless messaging channel to an engine (such as a search engine or a game engine, among others); and generating a result based on the speech symbols.

In yet another aspect, a system operates a mobile device with a message center; an engine (such as a search engine or a game engine, for example) coupled to the message center; and a mobile device wirelessly coupled to the message center, the mobile device capturing user speech, converting the user speech into one or more speech symbols; transmitting the speech symbols over a wireless messaging channel to the engine; and receiving a search result from the engine based on the speech symbols.

Implementations of the above aspects may include one or more of the following. The disambiguating symbol can be a location. The system can improve recognition accuracy based on the location information. The system can refine the result based on user history. The system can analyze usage pattern from a population of users to refine the result. The result can be ranked based on payment by an entity that is the target of the search. The system can search for one of: services, people, products and companies. The system can enhance a search for one of: services, people, products and companies by tailoring the search with one of: mobile device area code, zip code, airport code. The system can also enhance a search for one of: services, people, products and companies by tailoring the search with automated position determination. The automated position determination can include triangulation based location determination, WiFi location determination, GPS, assisted GPS, GLONASS, assisted GLONASS, GALILEO, or assisted GALILEO.

### BRIEF DESCRIPTION OF THE DRAWINGS

FIG. 1 shows a typical organization of network elements in a cellular network.

FIG. 2 shows an exemplary mobile device.

FIGS. 3A-3B show exemplary processes to display one or more multimedia files on a mobile device.

FIG. 4 shows an exemplary system to search for relevant multimedia files on a particular caller during a call.

FIG. 5 shows another exemplary process to perform verbal mobile phone searches.

FIG. 6 shows an exemplary process to edit video on a mobile device.

### DESCRIPTION

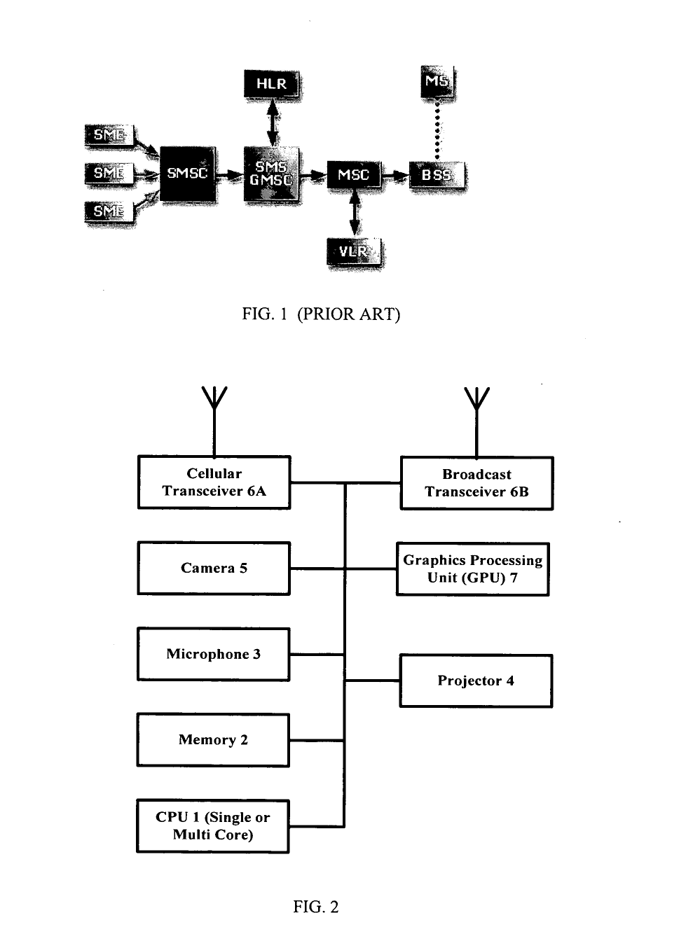

FIG. 1 shows a typical organization of network elements in a cellular network such as the GSM network supporting messaging such as SMS and MMS. It is a store and forward way of transmitting messages to and from mobile phones. The message (text only) from the sending mobile is stored in a central short message center (SMSC) which then forwards it to the destination mobile. The SMSC stores/forwards messages to and from the mobile station. The SME (Short Message Entity), which is typically a mobile phone or a GSM modem, can be located in the fixed network or a mobile station, receives and sends short messages. The SMS GMSC (SMS gateway MSC) is a gateway MSC that can also receive short messages. The gateway MSC is a mobile network's point of contact with other networks. On receiving the short message from the short message center, GMSC uses the SS7 network to interrogate the current position of the mobile station form the HLR, the home location register. HLR is the main database in a mobile network. It holds information of the subscription profile of the mobile and also about the routing information for the subscriber, i.e. the area (covered by a MSC) where the mobile is currently situated. The GMSC is thus able to pass on the message to the correct MSC. The MSC (Mobile Switching Center) is the entity in a GSM network which does the job of switching connections between mobile stations or between mobile stations and the fixed network. A VLR (Visitor Location Register) corresponds to each MSC and contains temporary information about the mobile, information like mobile identification and the cell (or a group of cells) where the mobile is currently situated. Using information form the VLR the MSC is able to switch the information (short message) to the corresponding BSS (Base Station System, BSC+BTSs), which transmits the short message to the mobile. The BSS consists of transceivers, which send and receive information over the air interface, to and from the mobile station. This information is passed over the signaling channels so the mobile can receive messages even if a voice or data call is going on.

FIG. 2 shows another embodiment as a portable data-processing device (such as a mobile phone, a camcorder, or a camera) having enhanced I/O peripherals and video editing capability. In one embodiment, the device has a processor 1 (which can have one core or can have a plurality of cores therein) connected to a memory array 2 that can also serve as a solid state disk. The processor 1 is also connected to a light projector 4, a microphone 3 and a camera 5.

An optional graphics processing unit (GPU) 7 is connected to the processor 1. For example, the GPU 7 may be NVIDIA's GoForce 5500 which focuses mainly on video decoding/encoding and 3D acceleration. The GPU 7 can playback H.264, WMV9 and MPEG4 (DivX/Xvid) in real time at native DVD resolutions and can also handle up to a 10-megapixel image size.

A cellular transceiver 6A is connected to the processor 1 to access cellular network including data and voice. The cellular transceiver 6A can communicate with CDMA, GPRS, EDGE or 4G cellular networks. In addition, a broadcast transceiver 6B allows the device to receive satellite transmissions or terrestrial broadcast transmissions. The transceiver 6B supports voice or video transmissions as well as Internet access. Other alternative wireless transceiver can be used. For example, the wireless transceiver can be WiFi, WiMax, 802.X, Bluetooth, infra-red, cellular transceiver all, one or more, or any combination thereof.

In one implementation, the transceiver 6B can receive XM Radio signals or Sirius signals. XM Radio broadcasts digital channels of music, news, sports and children's programming direct to cars and homes via satellite and a repeater network, which supplements the satellite signal to ensure seamless transmission. The channels originate from XM's broadcast center and uplink to satellites or high altitude planes or balloons acting as satellites. These satellites transmit the signal across the entire continental United States. Each satellite provides 18 kw of total power making them the two most powerful commercial satellites, providing coast-to-coast coverage. Sirius is similar with 3 satellites to transmit digital radio signals. Sirius's satellite audio broadcasting systems include orbital constellations for providing high elevation angle coverage of audio broadcast signals from the constellation's satellites to fixed and mobile receivers within service areas located at geographical latitudes well removed from the equator.

In one implementation, the transceiver 6B receives Internet protocol packets over the digital radio transmission and the processor enables the user to browse the Internet at high speed. The user, through the device, makes a request for Internet access and the request is sent to a satellite. The satellite sends signals to a network operations center (NOC) who retrieves the requested information and then sends the retrieved information to the device using the satellite.

In another implementation, the transceiver 6B can receive terrestrial Digital Audio Broadcasting (DAB) signal that offers high quality of broadcasting over conventional AM and FM analog signals. In-Band-On-Channel (IBOC) DAB is a digital broadcasting scheme in which analog AM or FM signals are simulcast along with the DAB signal The digital audio signal is generally compressed such that a minimum data rate is required to convey the audio information with sufficiently high fidelity. In addition to radio broadcasts, the terrestrial systems can also support internet access. In one implementation, the transceiver 6B can receive signals that are compatible with the Ibiquity protocol.

In yet another embodiment, the transceiver 6B can receive Digital Video Broadcast (DVB) which is a standard based upon MPEG-2 video and audio. DVB covers how MPEG-2 signals are transmitted via satellite, cable and terrestrial broadcast channels along with how such items as system information and the program guide are transmitted. In addition to DVB-S, the satellite format of DVB, the transceiver can also work with DVB-T which is DVB/MPEG-2 over terrestrial transmitters and DVB-H which uses a terrestrial broadcast network and an IP back channel. DVB-H operates at the UHF band and uses time slicing to reduce power consumption. The system can also work with Digital Multimedia Broadcast (DMB) as well as terrestrial DMB.

In yet another implementation, Digital Video Recorder (DVR) software can store video content for subsequent review. The DVR puts TV on the user's schedule so the user can watch the content at any time. The DVR provides the power to pause video and do own instant replays. The user can fast forward or rewind recorded programs.

In another embodiment, the device allows the user to view IPTV over the air. Wireless IPTV (Internet Protocol Television) allows a digital television service to be delivered to subscribing consumers using the Internet Protocol over a wireless broadband connection. Advantages of IPTV include two-way capability lacked by traditional TV distribution technologies, as well as point-to-point distribution allowing each viewer to view individual broadcasts. This enables stream control (pause, wind/rewind etc.) and a free selection of programming much like its narrowband cousin, the web. The wireless service is often provided in conjunction with Video on Demand and may also include Internet services such as Web access and VOIP telephony, and data access (Broadband Wireless Triple Play). A set-top box application software running on the processor 210 and through cellular or wireless broadband internet access, can receive IPTV video streamed to the handheld device.

IPTV covers both live TV (multicasting) as well as stored video (Video on Demand VOD). Video content can be MPEG protocol. In one embodiment, MPEG2TS is delivered via IP Multicast. In another IPTV embodiment, the underlying protocols used for IPTV are IGMP version 2 for channel change signaling for live TV and RTSP for Video on Demand. In yet another embodiment, video is streamed using the H.264 protocol in lieu of the MPEG-2 protocol. H.264, or MPEG-4 Part 10, is a digital video codec standard, which is noted for achieving very high data compression. It was written by the ITU-T Video Coding Experts Group (VCEG) together with the ISO/IEC Moving Picture Experts Group (MPEG) as the product of a collective partnership effort known as the Joint Video Team (JVT). The ITU-T H.264 standard and the ISO/IEC MPEG-4 Part 10 standard (formally, ISO/IEC 14496-10) are technically identical, and the technology is also known as AVC, for Advanced Video Coding. H.264 is a name related to the ITU-T line of H.26x video standards, while AVC relates to the ISO/IEC MPEG side of the partnership project that completed the work on the standard, after earlier development done in the ITU-T as a project called H.26L. It is usual to call the standard as H.264/AVC (or AVC/H.264 or H.264/MPEG-4 AVC or MPEG-4/H.264 AVC) to emphasize the common heritage. H.264/AVC/MPEG-4 Part 10 contains features that allow it to compress video much more effectively than older standards and to provide more flexibility for application to a wide variety of network environments. H.264 can often perform radically better than MPEG-2 video-typically obtaining the same quality at half of the bit rate or less. Similar to MPEG-2, H.264/AVC requires encoding and decoding technology to prepare the video signal for transmission and then on the screen 230 or substitute screens (STB and TV/monitor, or PC). H.264/AVC can use transport technologies compatible with MPEG-2, simplifying an up-grade from MPEG-2 to H.264/AVC, while enabling transport over TCP/IP and wireless. H.264/AVC does not require the expensive, often proprietary encoding and decoding hardware that MPEG-2 depends on, making it faster and easier to deploy H.264/AVC solutions using standards-based processing systems, servers, and STBs. This also allows service providers to deliver content to devices for which MPEG-2 cannot be used, such as PDA and digital cell phones.

The H.264/AVC encoder system in the main office turns the raw video signals received from content providers into H.264/AVC video streams. The streams can be captured and stored on a video server at the headend, or sent to a video server at a regional or central office (CO), for video-on-demand services. The video data can also be sent as live programming over the network. Standard networking and switching equipment routes the video stream, encapsulating the stream in standard network transport protocols, such as ATM. A special part of H.264/AVC, called the Network Abstraction Layer (NAL), enables encapsulation of the stream for transmission over a TCP/IP network. When the video data reaches the handheld device through the transceiver 6B, the application software decodes the data using a plug-in for the client's video player (Real Player and Windows Media Player, among others).

In addition to the operating system and user selected applications, another application, a VOIP phone application executes on the processing unit or processor 1. Phone calls from the Internet directed toward the mobile device are detected by the mobile radio device and sent, in the form of an incoming call notification, to the phone device (executing on the processing unit 1). The phone device processes the incoming call notification by notifying the user by an audio output such as ringing. The user can answer the incoming call by tapping on a phone icon, or pressing a hard button designated or preprogrammed for answering a call. Outgoing calls are placed by a user by entering digits of the number to be dialed and pressing a call icon, for example. The dialed digits are sent to the mobile radio device along with instructions needed to configure the mobile radio device for an outgoing call using either the cellular transceiver 6A or the wireless broadcast transceiver 6B. If the call is occurring while the user is running another application such as video viewing, the other application is suspended until the call is completed. Alternatively, the user can view the video in mute mode while answering or making the phone call.

The light projector 4 includes a light source such as a white light emitting diode (LED) or a semiconductor laser device or an incandescent lamp emitting a beam of light through a focusing lens to be projected onto a viewing screen. The beam of light can reflect or go through an image forming device such as a liquid crystal display (LCD) so that the light source beams light through the LCD to be projected onto a viewing screen.

Alternatively, the light projector 4 can be a MEMS device. In one implementation, the MEMS device can be a digital micro-mirror device (DMD) available from Texas Instruments, Inc., among others. The DMD includes a large number of micro-mirrors arranged in a matrix on a silicon substrate, each micro-mirror being substantially of square having a side of about 16 microns.

Another MEMS device is the grating light valve (GLV). The GLV device consists of tiny reflective ribbons mounted over a silicon chip. The ribbons are suspended over the chip with a small air gap in between. When voltage is applied below a ribbon, the ribbon moves toward the chip by a fraction of the wavelength of the illuminating light and the deformed ribbons form a diffraction grating, and the various orders of light can be combined to form the pixel of an image. The GLV pixels are arranged in a vertical line that can be 1,080 pixels long, for example. Light from three lasers, one red, one green and one blue, shines on the GLV and is rapidly scanned across the display screen at a number of frames per second to form the image.

In one implementation, the light projector 4 and the camera 5 face opposite surfaces so that the camera 5 faces the user to capture user finger strokes during typing while the projector 4 projects a user interface responsive to the entry of data. In another implementation, the light projector 4 and the camera 5 on positioned on the same surface. In yet another implementation, the light projector 4 can provide light as a flash for the camera 5 in low light situations.

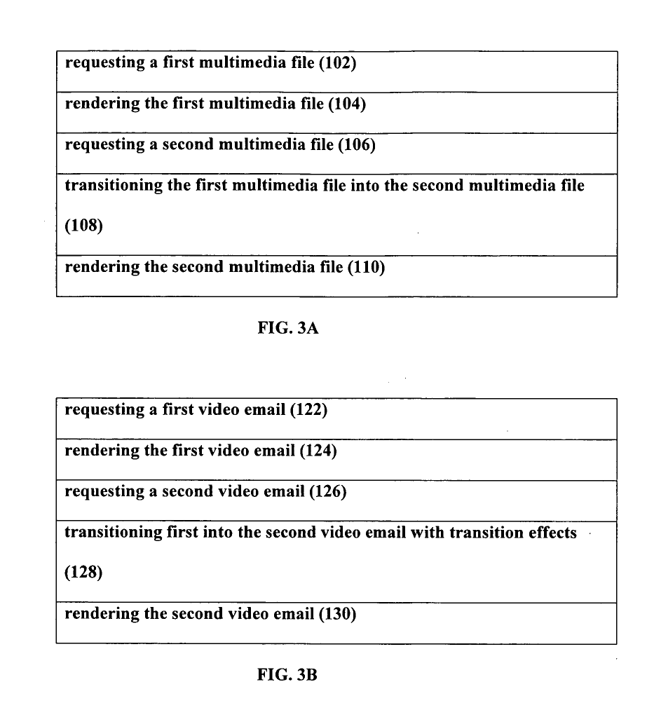

FIG. 3 shows an exemplary process to display one or more multimedia files on a mobile device. Any device with a display can be used to render multimedia files such as videos and pictures, one embodiment can be a wireless device such as a conventional cell phone. In another embodiment, a video cell phone can be used. In another embodiment, the device of FIG. 2 can be used.

Turning now to FIG. 3, a user requests a first multimedia file such as a video or a picture by providing an action to the mobile device (102). This can be done by shaking the phone and sensing the shaking with 1D, 2D or 3D accelerometers in the phone. The request can also be done using a keypad input or a touch screen input to request a file. The phone responds by rendering the first multimedia file (104). After viewing the first file, the user can request a second multimedia file (106). This can be done by shaking the phone or by using any other suitable indications to the phone. The process transitions the first multimedia file into the second multimedia file (108). This can be done using transition effects or by morphing one file output into the other file output. The mobile device then renders the second multimedia file (110).

In one embodiment, in 108, transitions can be used to change from one multimedia file to another. Cut is the most common transition—an instant change from one shot to the next. The raw footage from the camera contains cuts between shots where the photographer or videographer stops and starts recording. The transitions can also include Mix/Dissolve/Crossfade—a gradual fade from one shot to the next. Crossfades have a more relaxed feel than a cut and are useful if the user wants a meandering pace, contemplative mood, etc. Scenery sequences work well with crossfades, as do photo montages. Crossfades can also convey a sense of passing time or changing location. The fade transition fades the shot to a single colour, usually black or white. The “fade to black” and “fade from black” are ubiquitous in film and television. They usually signal the beginning and end of scenes. Fades can be used between shots to create a sort of crossfade which, for example, fades briefly to white before fading to the next shot. In a wipe transition, one shot is progressively replaced by another shot in a geometric pattern. There are many types of wipe, from straight lines to complex shapes. Wipes often have a coloured border to help distinguish the shots during the transition. Wipes can be used to show changing location. Digital effect transitions include morphing, color replacement, animated effects, pixelization, focus drops, lighting effects, among others.

In one embodiment, the first video or picture breaks into video fragments displayed as snowflakes that eventually transition into the second video. The simulated snowfall provides a cool and refreshing sense for the viewer to enjoy his or her favorite moments. Each video fragment can show a static image or can show a video playing within the snow flake. Particle physics can be affiliated with each snow flake video fragment to provide realism. In one embodiment, video fragments are broken into individual flakes, which are elevated and deposited in front of a scene. In another embodiment, the video fragments are broken into snow flakes which are distributed so that they fall uniformly across the width of the display. In another embodiment, discrete snow simulating video fragments are suspended and have sufficient weight to fall under simulated gravity through a simulated liquid. The user manually picks the mobile device up and turns it upside down long enough to allow the particles to accumulate at the top of the case. By then righting the mobile device, the video fragments or video particles float downwardly to simulate a shower of snow on the screen. In addition to favorite moments, other information can be shown in the form of snow flakes. For example, stock charts, industrial indices, health status (blood pressure level, EKG, etc), business reports and dashboard reports, can be shown in an enjoyable and relaxing form as snow flakes.

In one embodiment, the device can be a mobile phone. In another embodiment, the device can be a ball or snow globe with built-in display. The system can display multimedia files at any time for the user to review his or her favorite moments on demand.

In one embodiment, the multimedia files can be a video electronic mail (video email), a video mail, a video message, a video recording, a video conference. For video phones, a caller may leave a message in the form of a video mail as opposed to conventional voicemails. The recipient can download the video mails and sequentially play each video mail with the snow flake transition effect. The video mail functions are provided by a video mail server. Upon the occurrence of certain events, such as a video telephone line being busy or unanswered, the telephone system will signal the call (in a process typically referred to as “roll-over” to the video mail server. The video mail server will receive the telephone call thereby opening a recording session. During the recording session, the video mail server will prompt the caller to leave a message, capture the audiovisual stream from the caller, and store the captured audiovisual stream for subsequent play back to the video mail box owner. The recorded message is typically stored in digital form. At some later point in time, the video mail box owner may call the video mail server to establish a play back session. During the play back session, the server will prompt the video mail box owner to authenticate him or her self, retrieve the stored message, and generate a multimedia stream to the telephone system from which the video mail box owner called into the server. When setting up the recording session, the server and the remote device (used by the caller) will negotiate a specific compression algorithm. Then, during the recording session, the video mail server will receive a sequence of packets over a UDP/IP channel, for example. Each RTP packet includes one or more audio frames compressed using the negotiated compression algorithm. Each compressed audio frame represents a fixed time interval (on the order of 10 milliseconds) of video. The server sequences and decompresses each compressed video frame to regenerate digital video for storage.

FIG. 3B shows an exemplary process for playing video mails. First, the recipient requests a first video email (122). The process renders the first video email (124). During or at the end of the first video mail, the recipient requests a second video email (126). The process transitions the first into the second video email with transition effects (128). The transition effects can be snow flakes or other transitions as discussed above. The process then renders the second video email (130). Additional video mails can be rendered accordingly.

In the above video mail embodiments, a video mail delivery system generates and transmits video mail between a sender computer and a receiver computer over a communications network, such as the Internet. A video mail file containing audio and video content is recorded in a standard audio video interleave format and is then reformatted and compressed into an advanced streaming format. A video mail message window on the sender computer display enables the addition of an electronic text message to the video mail. A hyperlink to the compressed video mail file is inserted automatically into the video mail message window. When the video mail message is sent, the compressed video mail file is transmitted to a video store and forward server that stores the video mail file until it is accessed by the destination receiver computer. The electronic text message and hyperlink to the video mail file are sent to the electronic mail server of an Internet services provider for delivery to the mail server of the receiver computer's Internet services provider. When the electronic text message is opened, the user at the receiver computer clicks on the hyperlink to have the selected video file streamed from the video server to the receiver computer, where it is viewed in a video mail window display. The receiver computer can download the video mails and sequentially play each video mail with the snow flake transition effect.

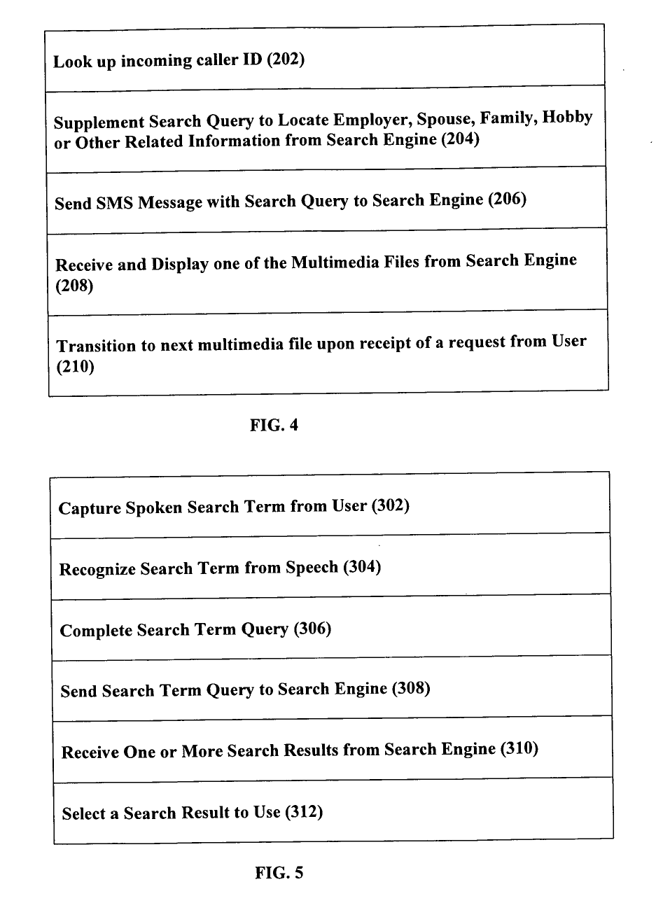

One embodiment locates relevant videos or pictures for rendering during a call. Relevant videos can be archived videos of the caller, for example. FIG. 4 shows an exemplary system to search for relevant multimedia files on a particular caller during a call. When a call is received, the system looks up incoming caller ID to identify the caller (202). The system supplements a Search Query to Locate Employer, Spouse, Family, Hobby or Other Related Information from Search Engine (204). Next, the system sends a search query such as an SMS Message or a WAP search request to a Search Engine (206). The system then receives and displays one of the multimedia files from the Search Engine (208). The file is displayed as long as the user is interested in the file. The system transitions to next multimedia file upon receipt of a request from User (210).

The system can optionally search predefined categories as well as undefined categories. For examples, the predefined categories can be sports, stocks, flight status, package tracking, price comparison, weather, yellow pages, movie show times, wifi hotspots, news, hotel reservations, drink recipes, jokes, horoscopes, or pickup lines, for example. In yet other embodiments, the search system can provide mobile access to virtually any type of live and on-demand audio content, including Internet-based streaming audio, radio, television or other audio source. Wireless users can listen to their favorite music, catch up on the latest news, or follow their favorite sports.

The system can also automatically send information to the mobile device via text messages. An alert can be created for specific sports teams, leagues, weather reports, horoscopes, stock quotes and more. Alerts can be set on a regular delivery schedule or for event-triggers such as stock quote and sports score changes. Event-triggered alerts keep users informed about real-time changes to things that they care about. For example, sports alerts can provide instant updates at the end of a period, inning, quarter, half, game or golf round for MLB, NBA, NFL, NHL, PGA and all major college sports, instant updates when the score changes (excluding NBA) Stock Alerts, instant updates for user-specified stocks or funds at market open and/or close, or instant updates for designated percentage change in price or specified price targets, among others. “By giving users the choice to receive event-triggered alerts, users can stay current on the latest changes in their portfolio or with their favorite teams, they can make more informed decisions, save time, and stay in the know continuously about subjects and events that are important to them. Event-triggered alerts are an addition to periodic alerts that can be scheduled for delivery at the time and preference of the user. Periodic alerts include 5-day weather forecasts, daily horoscopes, plus sports and stock alerts that can be set to a time of day instead of an event.

In one implementation, an audio alert can be sent. First, an SMS notification (text) announcing the alert is sent to the subscriber's cell phone. A connection is made to the live or on-demand audio stream. The user listens to the announcement as a live or on-demand stream. The system provides mobile phone users with access to live and on-demand streaming audio in categories such as music, news, sports, entertainment, religion and international programming. Users may listen to their favorite music, catch-up on latest news, or follow their sports team. The system creates opportunities for content providers and service providers, such as wireless carriers, with a growing content network and an existing and flourishing user base. Text-based or online offerings may be enhanced by streaming live and on-demand audio content to wireless users.

FIG. 5 shows another exemplary process in accordance with one embodiment of a mobile system such as a cell phone that can perform verbal mobile phone searches. First, the mobile system captures spoken speech from a user relating to a desired search term (302). A speech recognition engine recognizes the search term from the user's spoken request (204). The system then completes a search term query (306) as needed. The system then sends the complete search term query to one or more search engines (308). The search engine can be a taxonomy search engine as described below. The system retrieves one or more search results from the search engine(s) (310), and presents the search result(s) to the user (312). The user can view the contents found by the search.

In addition to SMS or MMS, the system can work with XHTML, Extensible Hypertext Markup Language, also known as WAP 2.0, or it can work with WML, Wireless Markup Language, also known as WAP 1.2. XHTML and WML are formats used to create Web pages that can be displayed in a mobile Web browser. This means that Web pages can be scaled down to fit the phone screen.

In one embodiment, the search engine is a taxonomy search engine (TSE). TSE is a web service approach to federating taxonomic databases such as Google or specialized databases from retailers, for example. The system takes the voice based query (expressed in phonemes, for example), converts the speech symbols into query text and the query is sent to a number of different databases, asking each one whether they contain results for that query. Each database has its own way of returning information about a topic, but the details are hidden from the user. TSE converts the speech symbols into a search query and looks up the query using a number of independent taxonomic databases. One embodiment uses a wrapper-mediator architecture, where there is a wrapper for each external database. This wrapper converts the query into terms understood by the database and then translates the result into a standard format for a mediator which selects appropriate information to be used and formats the information for rendering on a mobile phone.

In another embodiment, the system can handle structured and unstructured databases. The system uses ontologies, each of which is a vocabulary detailing all the significant words for a particular domain, like healthcare or music or video or a consumer item, and the relationship between each word. The system then recognizes these terms in their particular context.

A plurality of ontology systems can be used: one ontology to analyze unstructured information, another to analyze databases or other structured information, and a third to unify the two by data sets. So while a music listener can think of ‘U2′ as a band, a cell phone can think of ‘U2′ as a ring-tone, a newspaper might refer to a ‘U2′ for an incident, a military database might use the terms ‘U2′ for a spying plane, among others. In one implementation, the system semi-automatically builds and maintains domain specific ontologies. The system performs automatic detection and extraction of events in textual data and integrates the textual temporal information which has been extracted, in a document warehouse. The system provides temporal knowledge discovery of items for trends analysis.

In one aspect, the system semi-automatically builds and maintains domain specific ontologies. The system automatically generates ontology by examining numerous samples of the type of information typically being searched. The system then analyzes and produces a provisional ontology, which can be adjusted by users' acceptance or rejection of the search results to create a definitive ontology.

In another exemplary TSE, the system searches taxonomic databases that are related together. For instance, if the mobile device user enters “U2”, the system based on the ontological and/or taxonomical knowledge of “U2” searches databases relating to music, and locating music vendors of similar content as search results. The search results are provided as a series of links that are displayed on the mobile device for the user to select. In one option, the user can select an item and request the vendor to call the user back to complete the sales transaction. In another option, the system automatically fills in an order form and displays to the user for approval prior to submitting the information to the selected vendor. In one implementation, the vendor in turn pays a commission to the system for the sales referral.

In one embodiment, the system includes a multidimensional knowledge map. The knowledge map includes concepts. The concepts are organized into taxonomies. Each taxonomy includes a hierarchical structure. One taxonomy can be a first concept that is ordered with respect to a second concept independent of the hierarchical structure. The content provider system also includes content items. The items can be tagged to the concepts using a value of a structured data attribute associated with the items. In one example, the tagged item is selected from the group consisting of a user query, a user attribute, and a resource. In another example, the item is tagged to at least one of the concepts using at least one keyword included in the item. In another example, the first concept includes a first mapping function including an input and an output. The input of the first mapping function includes a value of a structured data attribute of at least one item. The output of the first mapping function indicates whether to tag the item to the first concept. In a further example, the second concept includes a second mapping function. The second mapping function includes an input and an output. The input of the second mapping function includes a value of a structured data attribute of at least one item. The output of the mapping function indicates whether to tag the at least one item to the second concept, such that the at least one item tagged to the first concept is ordered with respect to the at least one item tagged to the second concept. In one example, the input of the first mapping function includes information obtained from a source external to the system that is used in providing the output of the first mapping function. In another example, the input of the first mapping function uses information about how the at least one item tags to other concepts in providing the output of the first mapping function. In a further example, the input of the first mapping function uses information about at least one keyword included in the at least one item in providing the output of the first mapping function.

The system can have a multidimensional knowledge map. The system can execute a process that includes organizing concepts into groups representing dimensions of a domain, including ordering a first concept with respect to a second concept in the same group, using at least one structured data parameter, tagging at least one item to at least one of the first and second concepts, and constraining a user's search to only one of the first and second concepts. In another embodiment, one or more items are tagged to at least one of the first and second concepts based at least in part on a first structured data parameter that is modified based on an indication derived from at least one previous user's interaction with the system. In one variation on this embodiment, the tagging is also based on at least one of: a second structured data parameter, language associated with the item, and a second tag associated with the at least one item. In another example, the tagging is also based on at least one of whether the at least one previous user's interaction with the system was deemed successful and context information obtained from a dialog interaction with the at least one previous user. In one embodiment, a gateway provides the search service to POTS/PSTN mobile device callers with minimum modification of the existing system.

In one embodiment, an inquiry can be entered by a mobile device user. The mobile device user can type the inquiry on the mobile device keypad or speak the inquiry to the phone. In one embodiment, the spoken inquiry is captured by the server and speech recognition software at the server can convert the spoken inquiry into text and sent back to the display of the phone for confirmation. In another embodiment, the spoken inquiry can be converted into phonetic equivalent and transmitted as a message such as SMS message or email or WAP message to the server. As noted, the inquiry can be a natural language query, a boolean logic query specifying one or more search terms, or any combination thereof. The server then processes the received inquiry. For example, the inquiry can be parsed to identify keywords, search terms, and boolean operators. If the inquiry is a natural language inquiry, the language can be grammatically parsed to identify likely search terms and discard words which are not relevant to the subject or domain of the inquiry.

Next, the server can determine whether a relevant taxonomy model exists. In particular, using the search terms, the server can examine previously determined taxonomy models to determine whether the domains, types, and/or sub-types of an existing taxonomy model include any common information such as search terms. This determination can be performed with reference to the dictionary and thesaurus databases. That is, the search for an existing taxonomy model can be expanded to include terms specified by the dictionary and/or thesaurus databases which are synonymous and/or related to terms of the inquiry. Accordingly, although an inquiry may not include terminology that is identical to an existing taxonomy model, the server can identify related models by cross referencing the taxonomy model terminology with the inquiry terminology using the dictionary and thesaurus databases. As the dictionary and thesaurus databases can include both predetermined information as well as user configured information, the user can specify relationships between terms and domains such that the server can identify relationships among inquiries and existing taxonomy models despite the existence of only an indirect relationship between the inquiry and taxonomy model.

If one or more existing taxonomy models are found to have an association with the received inquiry, the identified taxonomy models can be used as a seed or basis for generating a new taxonomy model. In particular, attributes from the identified taxonomy models can be used as a baseline model. For example, Internet sites, search engines, databases, and/or Web pages used in the existing taxonomy model can be given higher priority than had no related taxonomy model been identified. Similarly, previously identified relationships between domain types, domain subtypes, and text passages of the existing taxonomy model can be re-examined by the server and used in recursive searches to be described herein in greater detail.

If no existing taxonomy model is relevant to the inquiry, a new taxonomy model is initialized. The server can access the dictionary database and the thesaurus database to identify alternative search terms and phrases to those specified in the inquiry. Accordingly, the server can broaden the scope of the inquiry to encompass synonymous, related, and/or relevant terms without requiring the user to specify an unduly large or complex inquiry. As the dictionary and thesaurus databases can include references to designated search engines suited to the subject matter of that entry, the server further can identify those search target engines which will be searched in response to the broadened inquiry. For example, if the user types “U2”, the server searches all music related sites for the available albums from “U2” since the search came from a phone and users are unlikely to search for U2 spy-planes on a mobile device. The user can be more specific and enter “U2 review” and the system would search Google or Yahoo or MSN search engines for reviews of the band, sort/filter/remove redundancy and presents articles that the user can review on the rather limited screen of the mobile device. Thus, the user can do research using the limited I/O of the phone if necessary, but the default is to assume that the user wants assistance to buy or to get to a particular location rather than to do in-depth research on the limited mobile device screen and keypad.

The server can generate and send queries based upon the initial user inquiry. The server can access the rules of the query protocol database to determine the query format associated with the target search engines. Accordingly the server can translate the received inquiry into one or more queries to be directed to the target search engines. Thus, each resulting query can conform the format required by the particular search engine to which the query is to be directed.

Results from the various target search engines can be received by the server. For example, from each of the target search engines, the server can receive a listing of references in response to the queries provided. The received references can be processed and prioritized. For example, the server can merge the various lists of URLs into a single list, remove duplicate URLs, and prioritize the remaining list according to the prioritization hierarchy specified by the research rules. Copies of the references specified by the processed listing of references can be retrieved. The text of the retrieved references can be extracted by removing any formatting tags or other embedded electronic document overhead. For example, any visual formatting of the text, content labeling of the data, or other data annotations can be removed from the retrieved references.

The server can take a course of action given the existence of particular word and/or text associations within a text passage including, but not limited to acronyms, syntactic variants, synonyms, semantic variants, and domain associations. For example, the rules can specify that a search is to be initiated for each identified acronym such that the resulting taxonomy model and report include information about the acronyms. Acronyms can be identified by identifying terms in all capital letters, using grammatical rules, and/or by specifying the terms within the dictionary and/or thesaurus databases.

Each of the aforementioned word and/or text associations identified within relevant text passages can be recursively identified within newly determined search results and recursively submitted to the various search engines to progressively acquire additional information. Taking another example, an original query for “jazz” can reveal that Acid Jazz, Avant Garde & Free Jazz, Bebop, Brazilian Jazz, Cool Jazz, Jazz Fusion, Jazz Jam Bands, Latin Jazz, Modern Postbebop, New Orleans Jazz, Smooth Jazz, Soul-Jazz & Boogaloo, Swing Jazz, Traditional Jazz & Ragtime, and Vocal Jazz are relevant terms. In this example, the system may recursively submit queries for each type of jazz music to progressively acquire further facts. The system may identify the top ten purchased or downloaded musician in a particular jazz music type and present that as the search sub-result to the user. The system is also aware of URLs of top retailers for a particular band and can add these URLs into the search sequence on a periodic basis such as on a daily or hourly basis.

After having identified the key relationships as well as the domain types and subtypes, a taxonomy model can be generated to summarize information discovered as a result of the inquiry. The taxonomy model can be formulated as a relational graph where nodes representing domain types are linked with child nodes clustered around the domain type. The child nodes represent the domain subtypes. Each of the nodes, whether a domain type or a domain sub-type, can include one or more attributes. Any incidental terms occurring infrequently can be pruned from the taxonomy model. Accordingly, the resulting clusters of domain types and domain sub-types represent the hierarchy between general and more specific concepts.

Off-line, the server can analyze the taxonomy model to identify patterns within the taxonomy model to provide faster and more accurate search results. The rules can specify particular relationships of interest in the taxonomy model. For example, the research rules can indicate that attributes which co-occur within one concept may be relevant to peer concepts, that concepts which share common attributes may form clusters of potential significance, relationships which divide clusters into mutually exclusive subsets are potentially significant, relationships which generate intersections among distinct clusters are potentially significant. The server can formulate additional sub-queries to provide the target search engines. For example, the sub-queries can specify new combinations of search terms such as domain types, domain subtypes, and attributes as determined from the research rules and the relational graph. Exemplary pattern rules can include “if type X has attribute Y, then search for other types with attributes of Y” and “if type X has attribute Y, then search for X having an attribute Y with alternative values for Y.” Continuing with the previous example, execution of the exemplary pattern rules can generate sub-queries such as “are there other items like U2 band.” The results of the sub-queries can be incorporated into the existing taxonomy model.

The determined taxonomy model can be presented to a system administrator for approval. The administrator can add elements to the taxonomy model, delete elements from the taxonomy model, and/or reorder the contents of the taxonomy model. Once the model is accepted by the administrator, edits to the taxonomy model can be incorporated. A report can be generated for review and can include the relational graph of the taxonomy model, a taxonomy outlining the domain of the taxonomy model, text descriptions of key concepts, attributes and relationships, as well as citations linking derived results to the original source documents. The resulting taxonomy model and research report can be stored for subsequent use.

The search result is accurate and provides relevant information for the needs of a mobile device user. The system brings the advantages of the Internet to mobile devices that are designed to work over the POTS/PSTN network. One such benefit is the ability to access Internet search engines for POTS/PSTN phones. It lends itself to various embodiments, each of which delivers the information in a text data format but in a different interface manner. The use of a gateway connection between the server and the POTS network provides the greatest degree of service expansion in that the text data may be provided in conjunction with a standard audio delivery, or it may be provided as a direct access database in which no voice call is involved. This is a high value added service which is of immediate benefit to both the client and the mobile device service provider. In consideration of its high value and in the flexibility of its delivery, the mobile device service provider has a variety of options in charging for the service. This may include a flat monthly subscription fee for all subscribers which eliminates the need for transaction billing, reducing both the service cost to the provider as well as the service charge to the customer.

In another aspect, a mobile device system for making free VOIP calls includes a handset with a display, a keypad, and a modem communicating with a remote server. The user make local and long distance calls for free and in addition may have access to value added services that include but not be limited to music, food, restaurant, movie, map, mobile device directory, news, blogs, weather, stocks, calendar, sports, horoscopes, lottery, messages, or traffic database. The display of the phone periodically shows information of interest to the user (such as ads), based on a profile that the user makes when registering with the system. The profile is updated to track services and products as the user actually uses.

Other revenue models can be used. In one embodiment, the system acts as brokers or market-makers: the system brings buyers and sellers together and facilitates transactions. Brokers play a frequent role in business-to-business (B2B), business-to-consumer (B2C), or consumer-to-consumer (C2C) markets. Usually a broker charges a fee or commission for each transaction it enables. The formula for fees can vary. Brokerage models include: Buy/Sell Fulfillment—takes customer orders to buy or sell a product or service, including terms like price and delivery; Demand Collection System—where a prospective buyer makes a final (binding) bid for a specified good or service, and the broker arranges fulfillment; Auction Broker—conducts auctions for sellers (individuals or merchants) Broker charges the seller a listing fee and commission scaled with the value of the transaction; Transaction Broker—provides a third-party payment mechanism for buyers and sellers to settle a transaction; Distributor—a catalog operation that connects a large number of product manufacturers with volume and retail buyers and where Broker facilitates business transactions between franchised distributors and their trading partners; Search Agent—a software agent or “robot” used to search-out the price and availability for a good or service specified by the buyer, or to locate hard to find information; Virtual Marketplace—or virtual mall, a hosting service for online merchants that charges setup, monthly listing, and/or transaction fees.

Alternatively, an advertising model can be used where advertisers pay for referrals or clicks from the mobile device. A high volume of user traffic makes advertising profitable and permits further diversification of site services. For example, the system can search classifieds—list items for sale or wanted for purchase. In another embodiment, the system provides free to access but require users to register and provide demographic data. Registration allows inter-session tracking of user surfing habits and thereby generates data of potential value in targeted advertising campaigns. The system can also support Contextual Advertising/Behavioral Marketing. For example, a mobile device extension that automates authentication and form fill-ins, also delivers advertising links or pop-ups as the user surfs the web. Contextual advertisers can sell targeted advertising based on an individual user's surfing activity. The system can support Content-Targeted Advertising that identifies the meaning of a web page and then automatically delivers relevant ads when a user visits that page. The system can display Intromercials—animated full-screen ads placed at the entry of a site before a user reaches the intended content.

In another business model, the system acts as an Infomediary that provides data about consumers and their consumption habits used to target marketing campaigns. Independently collected data about producers and their products are useful to consumers when considering a purchase.

In another embodiment, the system provides Incentive Marketing—customer loyalty program that provides incentives to customers such as redeemable points or coupons for making purchases from associated retailers. Data collected about users is sold for targeted advertising. The system can also be a Metamediary that facilitates transactions between buyer and sellers by providing comprehensive information and ancillary services, without being involved in the actual exchange of goods or services between the parties.

The system can also be a merchant, wholesalers and retailers of goods and services. Sales may be made based on list prices or through auction. The system can also be a merchant that deals strictly in digital products and services and, in its purest form, conducts both sales and distribution of contents such as music/video/call tone/ring tone over the web.

The system performs automatic detection and extraction of events in textual data and integrates the textual temporal information which has been extracted, in a document database. The system provides temporal knowledge discovery of items for trends analysis.

The system can use ontology with non-text information as well. Many repositories of digitized or electronic images, graphics, music and videos have been built. However, searching such multimedia files is still difficult. In one embodiment, the system performs speech recognition on the video and converts speech into text for searching. The converted text is stored as meta-tags associated with the music or video, and upon selection in response to a search, the music or video can be displayed for playing or for purchase.

In another embodiment, a system locates a predetermined multimedia file by having users upload a plurality of image, music and video files to a server, each file including multimedia data such as image or video or audio data and meta data describing the content; extracting the multi-media data and meta-data from the multimedia files; updating a search engine index with the meta-data; and subsequently locating the predetermined multimedia file using the search engine.

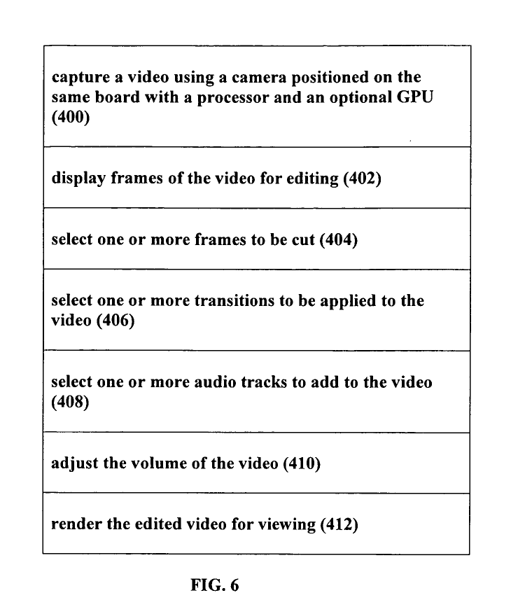

As shown in FIG. 6, an exemplary process to edit video on a mobile device captures a video using a camera positioned on the same board with a processor and an optional GPU (400) and displays frames of the video for editing (402). The process selects one or more frames to be cut (404) and selects one or more transitions to be applied to the video (406). The process can also select one or more audio to add to the video (408) and adjust the volume of the video (410). The process then renders the edited video for viewing (412). The process of FIG. 5 automatically detects the presence of the optional GPU 7 (FIG. 4) as well as multi-core engines in the processor 1 (FIG. 4) and takes advantage of the added hardware capabilities in editing and rendering video.

In another embodiment, as part of the content upload, the user captures and edits video taken with a mobile device such as a camcorder, a camera, a mobile phone, or a cell phone. The user performs simple edits to the video segment. The system allows the editing user more creative freedom at each step in the process, such as being able to preview and correct each edit decision on the fly. The video editing process becomes similar to putting together a document or graphics presentation where the user cuts and pastes the segments together adding effects and titles.

The software can provide Linear Editing where the content can only be edited sequentially similar to older mechanical techniques of cutting films to perform the edit functions. The software can alternatively provide Non-Linear Editing where editing in this environment is essentially is a visual Cut-and-Paste method and the user can edit any part of the video at will.

The system can provide In-Camera Editing: Video shots are structured in such a way that they are shot in order and of correct length. In another embodiment, the system allows the user to assemble edit: Video shots are not structured in a specific order during shooting but are rearranged and unneeded shots deleted at the time of transferring (copying). This process requires at the least, a Camcorder and VCR. the original footage remains intact, but the rearranged footage is transferred to a new tape. Each scene or cut is “assembled” on a blank tape either one-at-a-time or in a sequence. The system can provide two types of Assemble Editing: 1) A Roll—Editing from a single source, with the option of adding an effect, such as titles or transitioning from a frozen image the start of the next cut or scene and 2) A/B Roll—Editing from a minimum of two sources or Camcorders and recording to a third source. The system can also support insert editing where new material is recorded over existing footage. This technique can be used during the original shooting process or during a later editing process. The system provides Titles on Cardboard, Paper, or other Opaque Media—Painting titles on opaque media and recording the pages on videotape and inserting or assembling the title between scenes, previously shot, during the editing process.

The system supports audio or sound mixing where two or more sound sources can be connected to a sound mixer and then inputted into the video. The system also supports Audio Dubbing for adding audio to footage that is already edited together or previously shot. The audio is added to the video tape without altering the previously recorded video and, in some cases, without altering the previously recorded audio.

The above process is suitable for editing consumer produced content which tends to be short. In certain contents such as news or movies that take too long to transmit or view, the contents need to be reduced into chunks of one, five, ten or fifteen minutes, for example, to allow easy viewing while the user is traveling or otherwise don't have full attention on the device for an extended period. In one embodiment, video is micro-chunked to reduce entertainment to its simplest discrete form, be it a blog post, a music track, or a skit. Next, the system makes the content available and lets people download, view, read, or listen. The system lets consumers subscribe to content through RSS- and podcast-style feeds so they can enjoy it wherever and whenever they like. Optionally, the system can put ads and tracking systems into the digital content itself to provide revenue. In one implementation, the system provides microchunk videos entirely free, but it plays in a pop-up window alongside an ad or alternatively short commercials also play before some segments. The microchunks can be e-mailed, linked to, searched for, downloaded, remixed, and made available on-line.

The user or producer can embed meta data into the video or music. Exemplary meta data for video or musical content such as CDs includes artist information such as the name and a list of albums available by that artist. Another meta data is album information for the title, creator and Track List. Track metadata describes one audio track and each track can have a title, track number, creator, and track ID. Other exemplary meta data includes the duration of a track in milliseconds. The meta data can describe the type of a release with possible values of: TypeAlbum, TypeSingle, TypeEP, TypeCompilation, TypeSoundtrack, TypeSpokenword, TypeInterview, TypeAudiobook, TypeLive, TypeRemix, TypeOther. The meta data can contain release status information with possible values of: StatusOfficial, StatusPromotion, StatusBootleg. Other meta data can be included as well.

The meta-data can be entered by the videographer, the producer, the record company, or by a viewer or purchaser of the content. In one implementation, a content buyer (such as a video buyer of video content) can store his or her purchased or otherwise authorized content on the server in the buyer's own private directory that no one else can access. When uploading the multimedia files to the server, the buyer annotates the name of the files and other relevant information into a database on the server. Only the buyer can subsequently download or retrieve files he or she uploaded and thus content piracy is minimized. The meta data associated with the content is stored on the server and is searchable and accessible to all members of the community, thus facilitating searching of multimedia files for everyone.

In one implementation that enables every content buyer to upload his/her content into a private secured directory that cannot be shared with anyone else, the system prevents unauthorized distribution of content. In one implementation for music sharing that allows one user to access music stored by another user, the system pays royalty on behalf of its users and supports the webcasting of music according to the Digital Millennium Copyright Act, 17 U.S.C. 114. The system obtains a statutory license for the non-interactive streaming of sound recordings from Sound Exchange, the organization designated by the U.S. Copyright Office to collect and distribute statutory royalties to sound recording copyright owners and featured and non featured artists. The system is also licensed for all U.S. musical composition performance royalties through its licenses with ASCAP, BMI and SESAC. The system also ensures that any broadcast using the client software adheres to the sound recording performance complement as specified in the DMCA. Similar licensing arrangements are made to enable sharing of images and/or videos/movies.

The system is capable of indexing and summarizing images, music clips and/or videos. The system also identifies music clips or videos in a multimedia data stream and prepares a summary of each music video that includes relevant image, music or video information. The user can search the music using the verbal search system discussed above. Also, for game playing, the system can play the music or the micro-chunks of video in accordance with a search engine or a game engine instruction to provide better gaming enjoyment.

The methods described may be implemented in hardware, firmware, software, or combinations thereof, or in a computer program product tangibly embodied in a computer readable storage device. Storage devices suitable for tangibly embodying the computer program include all forms of volatile and non-volatile memory, including semiconductor memory devices, magnetic disks, magneto-optical disks, and optical disks.

The above process is suitable for editing consumer produced content which tends to be short. In certain contents such as news or movies that take too long to transmit or view, the contents need to be reduced into chunks of one, five, ten or fifteen minutes, for example, to allow easy viewing while the user is traveling or otherwise don't have full attention on the device for an extended period. In one embodiment, video is micro-chunked to reduce entertainment to its simplest discrete form, be it a blog post, a music track, or a skit. Next, the system makes the content available and lets people download, view, read, or listen. The system lets consumers subscribe to content through RSS- and podcast-style feeds so they can enjoy it wherever and whenever they like. Optionally, the system can put ads and tracking systems into the digital content itself to provide revenue. In one implementation, the system provides microchunk videos entirely free, but it plays in a pop-up window alongside an ad or alternatively short commercials also play before some segments. The microchunks can be e-mailed, linked to, searched for, downloaded, remixed, and made available on-line.

The user or producer can embed meta data into the video or music. Exemplary meta data for video or musical content such as CDs includes artist information such as the name and a list of albums available by that artist. Another meta data is album information for the title, creator and Track List. Track metadata describes one audio track and each track can have a title, track number, creator, and track ID. Other exemplary meta data includes the duration of a track in milliseconds. The meta data can describe the type of a release with possible values of: TypeAlbum, TypeSingle, TypeEP, TypeCompilation, TypeSoundtrack, TypeSpokenword, TypeInterview, TypeAudiobook, TypeLive, TypeRemix, TypeOther. The meta data can contain release status information with possible values of: StatusOfficial, StatusPromotion, StatusBootleg. Other meta data can be included as well.

The meta-data can be entered by the musician, the producer, the record company, or by a music listener or purchaser of the music. In one implementation, a content buyer (such as a video buyer of video content) can store his or her purchased or otherwise authorized content on the server in the buyer's own private directory that no one else can access. When uploading the multimedia files to the server, the buyer annotates the name of the files and other relevant information into a database on the server. Only the buyer can subsequently download or retrieve files he or she uploaded and thus content piracy is minimized. The meta data associated with the content is stored on the server and is searchable and accessible to all members of the community, thus facilitating searching of multimedia files for everyone.

In one implementation that enables every content buyer to upload his/her content into a private secured directory that cannot be shared with anyone else, the system prevents unauthorized distribution of content. In one implementation for music sharing that allows one user to access music stored by another user, the system pays royalty on behalf of its users and supports the web-casting of music according to the Digital Millennium Copyright Act, 17 U.S.C. 114. The system obtains a statutory license for the non-interactive streaming of sound recordings from Sound Exchange, the organization designated by the U.S. Copyright Office to collect and distribute statutory royalties to sound recording copyright owners and featured and non featured artists. The system is also licensed for all U.S. musical composition performance royalties through its licenses with ASCAP, BMI and SESAC. The system also ensures that any broadcast using the client software adheres to the sound recording performance complement as specified in the DMCA. Similar licensing arrangements are made to enable sharing of images and/or videos/movies.

The system is capable of indexing and summarizing images, music clips and/or videos. The system also identifies music clips or videos in a multimedia data stream and prepares a summary of each music video that includes relevant image, music or video information. The user can search the music using the verbal search system discussed above. Also, for game playing, the system can play the music or the micro-chunks of video in accordance with a search engine or a game engine instruction to provide better gaming enjoyment.

In one gaming embodiment, one or more accelerometers may be used to detect a scene change during a video game running within the mobile device. For example, the accelerometers can be used in a tilt-display control application where the user tilts the mobile phone to provide an input to the game. In another gaming embodiment, mobile games determine the current position of the mobile device and allow players to establish geofences around a building, city block or city, to protect their virtual assets. The mobile network such as the WiFi network or the cellular network allows players across the globe to form crews to work with or against one another. In another embodiment, digital camera enables users to take pictures of themselves and friends, and then map each digital photograph's looks into a character model in the game. Other augmented reality game can be played with position information as well.

“Computer readable media” can be any available media that can be accessed by client/server devices. By way of example, and not limitation, computer readable media may comprise computer storage media and communication media. Computer storage media includes volatile and nonvolatile, removable and non-removable media implemented in any method or technology for storage of information such as computer readable instructions, data structures, program modules or other data. Computer storage media includes, but is not limited to, RAM, ROM, EEPROM, flash memory or other memory technology, CD-ROM, digital versatile disks (DVD) or other optical storage, magnetic cassettes, magnetic tape, magnetic disk storage or other magnetic storage devices, or any other medium which can be used to store the desired information and which can be accessed by client/server devices. Communication media typically embodies computer readable instructions, data structures, program modules or other data in a modulated data signal such as a carrier wave or other transport mechanism and includes any information delivery media.

All references including patent applications and publications cited herein are incorporated herein by reference in their entirety and for all purposes to the same extent as if each individual publication or patent or patent application was specifically and individually indicated to be incorporated by reference in its entirety for all purposes. Many modifications and variations of this invention can be made without departing from its spirit and scope, as will be apparent to those skilled in the art. The specific embodiments described herein are offered by way of example only. The above specification, examples and data provide a complete description of the manufacture and use of the composition of the invention. Since many embodiments of the invention can be made without departing from the spirit and scope of the invention, the invention resides in the claims hereinafter appended.

What is claimed is:

1. A method to render graphics on a mobile device, comprising:
requesting a first multimedia file using an accelerometer;
rendering the first multimedia file;
requesting a second multimedia file using the accelerometer;
transitioning the first multimedia file into the second multimedia file; and
rendering the second multimedia file.

2. The method of claim 1, comprising displaying portions of the multimedia file as snow flakes.

3. The method of claim 1, wherein the transitioning comprises converting one or more frames of the first multimedia file into screen fragments and reassembling the screen fragments over one or more frames of the second multimedia file.

4. The method of claim 1, comprising downloading one or more multimedia files from a server to the mobile device.

5. The method of claim 1, wherein each multimedia file comprises a microchunk.

6. The method of claim 1, comprising capturing a multimedia file using a camera on the mobile device and editing the multimedia file.

7. The method of claim 6, wherein the multimedia file is edited on the mobile device or on a personal computer.

8. The method of claim 1, wherein the multimedia file comprises one of: a sound clip, an image, a video clip.

9. The method of claim 1, wherein the transitioning comprises cut, fade, crossfade, wipes, digital effect, morphing.

10. The method of claim 1, wherein the mobile device comprises one of: a plain old mobile device service (POTS) mobile device, a Voice Over Internet Protocol (VOIP) mobile device, a cellular mobile device, a WiFi mobile device, a WiMAX mobile device.

11. The method of claim 1, comprising performing automated position determination with one of: triangulation based location determination, WiFi location determination, GPS, assisted GPS, GLONASS, assisted GLONASS, GALILEO, assisted GALILEO.

12. The method of claim 1, comprising receiving a search query and searching one or more taxonomic databases based on the search query and returning a search result to the mobile device, wherein the taxonomic databases comprise one or more of: music, food, restaurant, movie, map, mobile device directory, news, blogs, weather, stocks, calendar, sports, horoscopes, lottery, messages, traffic, direction.

13. The method of claim 1, wherein one of the multimedia files comprises one of: a video electronic mail (video email), a video mail, a video message, a video recording, a video conference.

14. The method of claim 1, comprising transmitting multimedia files using MMS.

15. A mobile device, comprising:
a gesture input device;
a display; and
a processor having code to receive a request for a first multimedia file; code to render the first multimedia file; code to receive a request for a second multimedia file; code to transition the first multimedia file into the second multimedia file; and code to render the second multimedia file.

16. The device of claim 15, wherein the gesture input device comprises one of: an accelerometer, a tilt sensor, a gyroscope, a skin resistance sensor, an electro-myogram (EMG) sensor, an Electro-encephalogram (EEG) sensor, and Electro-oculogram (EOG) sensor, an electrocardiogram (EKG) sensor.

17. The device of claim 15, wherein the processor converts one or more frames of the first multimedia file into screen fragments and reassembling the screen fragments over one or more frames of the second multimedia file.

18. The device of claim 15, comprising a server to download one or more multimedia files to the mobile device.

19. The device of claim 15, wherein each multimedia file comprises a microchunk.

20. The device of claim 15, comprising a camera to capture a multimedia file and code to edit the multimedia file.
